(19) United States
(12) Patent Application Publication
(10) Pub. No.: US 2026/0031979 A1
(43) Pub. Date: Jan. 29, 2026

(54) INFORMATION PUBLISHING METHOD, INFORMATION PUBLISHING SYSTEM, INFORMATION ISSUING APPARATUS, DEVICE, PLATFORM AND MEDIUM

(71) Applicants: Beijing BOE Technology Development Co., Ltd., Beijing (CN); BOE Technology Group Co., Ltd., Beijing (CN)

(72) Inventors: Xitong MA, Beijing (CN); Xiaodong SHI, Beijing (CN); Youxiang XIA, Beijing (CN); Hua HUANG, Beijing (CN)

(21) Appl. No.: 18/996,303

(22) PCT Filed: Apr. 16, 2024
(86) PCT No.: PCT/CN2024/087979

§ 371 Date: Jan. 17, 2025

(30) Foreign Application Priority Data
May 31, 2023 (CN) 202310638602.9

(51) Int. Cl. H04L 9/08; H04L 9/14; H04L 9/32

(52) U.S. Cl. CPC H04L 9/0825; H04L 9/0869; H04L 9/14; H04L 9/3247; H04L 9/3263

(57) ABSTRACT

An information publishing method is disclosed and includes: decrypting a key cipher text sent by an internet of things platform in response to the key cipher text, to obtain a negotiation key; encrypting an original data packet to be issued by using the negotiation key to generate an encrypted data packet; the original data package includes original data of at least one data file, including at least one first original data set and second original data set, and the encrypted data packet includes: a first original data set of each data file and an encrypted data set generated by encrypting the second original data set by using the negotiation key; processing the encrypted data packet based on a first preset algorithm and the negotiation key to generate a summary cipher text; and sending target information including the summary cipher text and the encrypted data packet to the terminal device.

### TECHNICAL FIELD

The present disclosure relates to the field of internet of things technology, and in particular to an information publishing method, an information publishing system, an information issuing apparatus, a terminal device, an internet of things platform, an electronic device and a computer readable medium.

### BACKGROUND

In recent years, the internet of things technology is rapidly developed, which has profound influence on a basic industry of human society such as an agriculture, an industry, a service industry, and brings profound changes to the production and lifestyle of the society. The internet of things technology realizes the identification, monitoring, positioning, connection, tracking and management of devices by acquiring information from sensors in real time, so that the devices, network and interaction become more intelligent.

### SUMMARY

The present disclosure provides an information publishing method in an information issuing apparatus, and the information publishing method includes: in response to a key cipher text sent by an internet of things platform, decrypting the key cipher text to obtain a negotiation key, where the key cipher text is generated with a successful identity authentication for a terminal device by the internet of things platform; encrypting an original data packet to be issued by using the negotiation key to generate an encrypted data packet, where the original data package includes original data of at least one data file, including at least one first original data set and at least one second original data set, and the encrypted data packet includes: a first original data set of each data file and an encrypted data set generated by encrypting the second original data set by using the negotiation key; processing the encrypted data packet based on a first preset algorithm and the negotiation key to generate a summary cipher text; and sending target information including the summary cipher text and the encrypted data packet to the terminal device for obtaining the data in the original data packet by the terminal device according to the target information and the negotiation key.

In some embodiments, the processing the encrypted data packet based on the first preset algorithm and the negotiation key, includes: processing the encrypted data packet based on the first preset algorithm to generate a digital summary; and encrypting the digital summary by using the negotiation key to generate the summary cipher text.

In some embodiments, each data file is an image, and the image includes a plurality of first regions and a plurality of second regions which are arranged in an array and are alternately arranged in each row and each column in the array; and the at least one first original data set includes original image data of the plurality of first regions, and the at least one second original data set includes original image data of the plurality of second regions.

In some embodiments, the original data packet includes: original data of a plurality of frames of images, and in every two adjacent frames of images, positions of the plurality of first regions and the plurality of second regions are complementary to each other.

In some embodiments, after the decrypting the key cipher text sent by the internet of things platform in response to the key cipher text, the method further includes: decrypting an authentication message cipher text sent by the internet of things platform in response to the authentication message cipher text by using the negotiation key to obtain an authentication success message; where the encrypting the original data packet to be issued by using the negotiation key is performed after the authentication success message is obtained.

In some embodiments, before the decrypting the key cipher text sent by the internet of things platform in response to the key cipher text, the method further includes: submitting a fourth public key certificate to the internet of things platform for verifying the validity of the fourth public key certificate by the internet of things platform; where the fourth public key certificate records a fourth public key of the information issuing apparatus therein; and the decrypting the key cipher text, includes: decrypting the key cipher text by using a fourth private key; where the fourth public key and the fourth private key are paired and matched with each other and are all generated in advance by the information issuing apparatus.

In some embodiments, before the submitting the fourth public key certificate to the internet of things platform, the method further includes: generating the fourth private key and the fourth public key which are paired and matched with each other; sending the fourth public key to a certification authority all-in-one machine for signing the fourth public key by the certification authority all-in-one machine to generate the fourth public key certificate; and receiving and storing the fourth public key certificate sent by the certification authority all-in-one machine.

The present disclosure further provides an information publishing method for a terminal device, where the method includes: determining a negotiation key with a successful identity authentication for the terminal device; processing encrypted data packet in target information sent by an information issuing apparatus by using a first preset algorithm in response to the target information to obtain a first processing result; decrypting a summary cipher text in the target information by using the negotiation key, to obtain a second processing result; and determining whether the first processing result is the same as the second processing result, and decrypting the encrypted data packet by using the negotiation key to obtain original data of each data file in an original data packet if it is determined that the first processing result is the same as the second processing result; where the encrypted data packet includes data to be decrypted of at least one data file, the data to be decrypted includes: at least one first data set and at least one second data set, the original data of the data file includes: a first original data set which is the same as the at least one first data set, and a second original data set obtained by decrypting each second data set by using the negotiation key.

In some embodiments, the method further includes: submitting a first public key certificate to an internet of things platform for extracting a first public key of the terminal device from the first public key certificate by the internet of things platform with the first public key certificate being determined to be legal; decrypting a first cipher text sent by the internet of things platform in response to the first cipher text, where the first cipher text is generated by encrypting a first random number by the internet of things platform with the first public key, and the first random number is data randomly generated by the internet of things platform with a server cipher machine; generating a second cipher text based on a decryption result of the first cipher text; and sending the second cipher text to the internet of things platform for decrypting the second cipher text by the internet of things platform, and authenticating an identity of the terminal device based on a decryption result and the first cipher text.

In some embodiments, the generating the second cipher text based on the decryption result of the first cipher text, includes: generating a third random number; concatenating the first decryption result and the third random number to generate a second random number; and encrypting the second random number to generate the second cipher text.

In some embodiments, the encrypting the second random number, includes: extracting a third public key of the internet of things platform from a pre-acquired third public key certificate; and encrypting the second random number by using the third public key.

In some embodiments, the determining the negotiation key with the successful identity authentication for the terminal device, includes: taking the second random number as the negotiation key in response to an authentication message cipher text sent by the internet of things platform; and the method further includes: decrypting the authentication message cipher text by using the negotiation key to obtain an authentication success message.

In some embodiments, before the submitting the first public key certificate to the internet of things platform, the method further includes: generating a first public key and a first private key which are paired and matched with each other; submitting the first public key to an authentication server for signing the first public key by the authentication server to generate a first public key certificate; and receiving and storing the first public key certificate sent by the authentication server and a third public key certificate, where the third public key certificate records a third public key of the internet of things platform therein.

The present disclosure further provides an information publishing method for an internet of things platform, including: determining a negotiation key with a successful identity authentication for a terminal device; encrypting the negotiation key to generate a key cipher text; and sending the key cipher text to an information issuing apparatus for decrypting the key cipher text by the information issuing apparatus to obtain the negotiation key.

In some embodiments, the encrypting the negotiation key, includes: extracting a fourth public key of the information issuing apparatus from a pre-acquired fourth public key certificate; and encrypting the negotiation key by using the fourth public key.

In some embodiments, after the transmitting the key cipher text to the information issuing apparatus, the method further includes: generating an authentication success message; encrypting the authentication success message by using the negotiation key to generate an authentication message cipher text; and sending the authentication message cipher text to the terminal device and the information issuing apparatus.

In some embodiments, the method further includes: verifying a validity of a first public key certificate sent by the terminal device based on a second public key certificate sent by an authentication server in advance in response to the first public key certificate. and verifying a validity of a fourth public key certificate sent by the information issuing apparatus based on the second public key certificate in response to the fourth public key certificate; extracting a first public key of the terminal device from the first public key certificate, and a fourth public key of the information issuing apparatus from the fourth public key certificate with the first public key certificate and the fourth public key certificate passing the verification; generating a first random number by using a server cipher machine, and encrypting the first random number by using the first public key to generate a first cipher text; sending the first cipher text to the terminal device for decrypting the first cipher text by the terminal device to generate a second cipher text based on a decryption result of the first cipher text; decrypting the second cipher text in response to the second cipher text; and matching a decryption result of the second cipher text with the first random number, where it is determined that the identity authentication for the terminal device is successful if the decryption result of the second cipher text is successfully matched with the first random number.

In some embodiments, the determining the negotiation key with the successful identity authentication for the terminal device, includes: taking the decryption result of the second cipher text as the negotiation key with the successful identity authentication for the terminal device.

In some embodiments, the second cipher text is generated by encrypting a second random number by the terminal device with a third public key of the internet of things platform, the second random number is generated by concatenating the decryption result of the first cipher text and a third random number by the terminal device, and the third random number is generated by the terminal device randomly; and the decrypting the second cipher text, includes: decrypting the second cipher text with a third private key, where the third public key is paired and matched with the third private key.

In some embodiments, the verifying the validity of the first public key certificate based on the second public key certificate sent by the authentication server in advance, includes: extracting a second public key of the authentication server from the second public key certificate sent by the authentication server in advance; and verifying a signature of the first public key certificate by using the second public key; where it is determined that the first public key certificate is legal if the signature of the first public key certificate passes the verification; and the verifying the validity of the first public key certificate based on the second public key certificate, includes: extracting the second public key of the authentication server from the second public key certificate sent by the authentication server in advance; and verifying a signature of the fourth public key certificate by using the second public key; where it is determined that the fourth public key certificate is legal if the signature of the fourth public key certificate passes the verification.

In some embodiments, before the verifying the validity of the first public key certificate, the method further includes: receiving and storing the second public key certificate sent by the authentication server, where the second public key certificate records a second public key of the authentication server therein; generating a third public key and a third private key which are paired and matched with each other; and sending the third public key to the authentication server for signing the third public key by the authentication server with the second private key to generate a third public key certificate; and where the second public key is paired and matched with the second private key.

The present disclosure further provides an information issuing apparatus, including: a key acquisition module configured to decrypt a key cipher text sent by an internet of things platform in response to the key cipher text, to obtain a negotiation key, where the key cipher text is generated with a successful identity authentication for a terminal device by the internet of things platform; a data encryption module configured to encrypt an original data packet to be issued by using the negotiation key to generate an encrypted data packet, where the original data package includes original data of at least one data file, including at least one first original data set and at least one second original data set, and the encrypted data packet includes: a first original data set of each data file and an encrypted data set generated by encrypting the second original data set by using the negotiation key; a summary generation module configured to process the encrypted data packet by using a first preset algorithm to generate a digital summary; a summary encryption module configured to encrypt the digital summary based on the negotiation key to generate a summary cipher text; and an issuing module configured to send target information including the summary cipher text and the encrypted data packet to the terminal device for obtaining the data in the original data packet by the terminal device according to the target information and the negotiation key.

The present disclosure further provides a terminal device, including: a key determining module configured to determine a negotiation key with a successful identity authentication for the terminal device; a first processing module configured to process an encrypted data packet in target information sent by an information issuing apparatus by using a first preset algorithm in response to the target information to obtain a first processing result; a second processing module configured to decrypt a summary cipher text in the target information by using the negotiation key, to obtain a second processing result; and a decryption module configured to determine whether the first processing result is the same as the second processing result, and decrypt the encrypted data packet by using the negotiation key to obtain original data of each data file if the first processing result is the same as the second processing result; where the encrypted data packet includes data to be decrypted of at least one data file, and the data to be decrypted includes: at least one first data set and at least one second data set, and the original data of the data file includes: a first original data set which is the same as the at least one first data set, and a second original data set obtained by decrypting each second data set by using the negotiation key.

The present disclosure further provides an internet of things platform, including: a cipher text generation module configured to determine a negotiation key with a successful identity authentication for a terminal device by the internet of things platform, and encrypt the negotiation key to generate a key cipher text; and a cipher text sending module configured to send the key cipher text to an information issuing apparatus for decrypting the key cipher text by the information issuing apparatus to obtain the negotiation key.

The present disclosure further provides an information publishing system, including: the information issuing apparatus, the terminal device, and the internet of things platform.

In some embodiments, the information publishing system further includes: an authentication server configured to generate a second private key and a second public key certificate, where the second public key certificate records a second public key paired and matched with the second private key therein; sign a first public key sent by the terminal device by using the second private key in response to the first public key, to generate a first public key certificate; send the first public key certificate to the terminal device; send the second public key certificate to the internet of things platform; sign a third public key sent by the internet of things platform by using the second private key in response to the third public key, to generate a third public key certificate, and send the third public key certificate to the terminal device; sign a fourth public key sent by the information issuing apparatus by using the second private key in response to the fourth public key, to generate a fourth public key certificate, and send the fourth public key certificate to the information issuing apparatus.

The present disclosure provides an electronic device, including: one or more processors; and a storage device having one or more programs stored thereon, which when executed by the one or more processors, cause the one or more processors to implement the method in any one of the above embodiments.

The present disclosure provides a computer-readable storage medium storing instructions thereon which, when executed by a processor, cause the processor to implement the method in any one of the above embodiments.

### BRIEF DESCRIPTION OF DRAWINGS

The accompanying drawings provide a further understanding of the present disclosure and form a part of the specification. The drawings are used to explain the present disclosure together with the embodiments below, but do not constitute a limitation to the present disclosure. In the drawings:

FIG. 1 is a schematic diagram of an information publishing method according to some embodiments of the present disclosure.

FIG. 2A is a schematic diagram illustrating region division of a frame of image according to some embodiments of the present disclosure.

FIG. 2B is a schematic diagram illustrating region division of another frame of image according to some embodiments of the present disclosure.

FIG. 3 is a schematic diagram of an information publishing method according to further embodiments of the present disclosure.

FIG. 4 is a schematic diagram illustrating a certificate issuing process in some embodiments of the present disclosure.

FIG. 5 is a schematic diagram of an information publishing method according to further embodiments of the present disclosure.

FIG. 6 is a schematic diagram of an information publishing method according to further embodiments of the present disclosure.

FIG. 7 is a schematic diagram illustrating a certificate issuing process according to some embodiments of the present disclosure.

FIG. 8 is a schematic diagram of an information publishing method according to some embodiments of the present disclosure.

FIG. 9 is a schematic diagram of an information publishing method according to further embodiments of the present disclosure.

FIG. 10 is a schematic diagram of a certificate issuing process according to some embodiments of the present disclosure.

FIG. 11 is a diagram illustrating a certificate issuing process of an information publishing system according to some embodiments of the present disclosure.

FIG. 12 is a schematic diagram of an identity authentication process of an information publishing system according to some embodiments of the present disclosure.

FIG. 13 is a schematic diagram of an information issuing process of an information publishing system according to some embodiments of the present disclosure.

FIG. 14 is a schematic diagram of an information issuing apparatus according to some embodiments of the present disclosure.

FIG. 15 is a schematic diagram of a terminal device according to some embodiments of the present disclosure.

FIG. 16 is a schematic diagram of an internet of things platform according to some embodiments of the present disclosure.

FIG. 17 is a schematic diagram of an information publishing system according to some embodiments of the present disclosure.

### DETAIL DESCRIPTION OF EMBODIMENTS

The following detailed description of the embodiments of the present disclosure will be described in detail in combination with to the accompanying drawings. It should be understood that the embodiments described herein are only intended to illustrate and explain the present disclosure rather than to limit the present disclosure.

In order to make the objects, technical solutions and advantages of the embodiments of the present disclosure more apparent, the technical solutions of the embodiments of the present disclosure will be clearly and completely described below with reference to the drawings of the embodiments of the present disclosure. It is to be understood that the described embodiments are only a few embodiments of the present disclosure, and not all embodiments. All other embodiments, which can be derived by a person skilled in the art from the described embodiments of the present disclosure without inventive work, fall into the protection scope of the present disclosure.

Unless otherwise defined, technical or scientific terms in the embodiments of the present disclosure should have the ordinary meaning as understood by one of ordinary skill in the art to which the present disclosure belongs. The terms such as “first,” “second,” and the like in the present disclosure are not intended to indicate any order, quantity, or importance, but are used to distinguish one element from another.

In order to facilitate an understanding of the embodiments of the present disclosure, before illustrating the embodiments of the present disclosure in detail, specific terms related to the present disclosure are explained as follows:
(1) The certification authority (CA) all-in-one machine is an international term for certification bodies, and is the organization that issues, manages, and cancels digital certificates for applicants of the digital certificates. The role of the CA is to verify the validity of the identity of the certificate holder and issue a certificate (i.e., sign mathematically on the certificate) to prevent the certificate from being forged or tampered with. The certificate authority (CA) is a key link in the security of online electronic transactions, and is mainly responsible for generating, allocating, and managing the identity authentication digital certificates required by all entities participating in the online transactions. Each digital certificate is associated with a previous-level digitally signed certificate, and ultimately traced back, through a security chain, to a known and widely recognized secure, authoritative, and trustworthy organization, that is, a Root Certification Authority (i.e., the Root CA).
(2) The server cipher machine is a server-side password computing device that provides universal password service functions such as key generation, digital signature, signature verification, data encryption, and data decryption. The server cipher machine is a device that implements the transformation of plaintext to cipher text or the transformation of cipher text to plaintext, under the influence of a key. In the embodiment of the present disclosure, basic security services such as data encryption and decryption are provided by the server cipher machine for the internet of things platform.
(3) A digital signature (also known as a public key digital signature) is a string of digits that is only generated by a sender of information and cannot be forged by others. This string of digits is also an effective proof of the authenticity of the information sent from the sender. The digital signature is similar to a regular physical signature written on paper and is realized through techniques in the field of public key encryption for identifying digital information. A set of digital signatures typically defines two complementary operations, one of which is for signing/signature and the other is for verifying (i.e. verifying the signature). The signature in the embodiment of the present disclosure is signed with the private key and is verified with the public key.

In the embodiment of the present disclosure, the process of signing data A with a certain private key a may include: processing data A′ to be signed containing the data A through a hash algorithm to generate a first hash value: encrypting the first hash value by using the private key a to generate a digital signature: and generating signature data D based on the digital signature and the data A′ to be signed. When the digital signature is verified, the process may include decrypting the digital signature by using a public key a′ in pair with the private key a, and processing the data D by using a hash function to obtain a second hash value: and comparing the second hash value with the decryption result of the digital signature, and the digital signature is verified successfully in a case that the second hash value is the same as the decryption result of the digital signature.
(4) A digital certificate (also known as a public key certificate) is a declaration of a digital signature that binds a value of a public key to an identity of the individual, device, or service holding a corresponding private key. Most general-purpose certificates are based on X.509v3 certificate standard.
(5) Hash, commonly translated or transliterated as hash, transforms (also known as a pre mapping/pre-imaging) an input with any length into an output (i.e., the hash value) with a fixed length through a hash algorithm. The transformation is a compression mapping, which means that a space of the hash values is in generally much smaller than that of the inputs, and different inputs may be hashed into the same output, therefore it is impossible to determine a unique input value from the hash values. Simply put, the Hash is a function that compresses messages with any length into a message digest with a fixed length.
(6) The internet of things platform is an integrated platform that integrates functions such as device management, data security communication, and message subscription. The internet of things platform supports connecting massive devices downwards, collecting data from the devices, and uploading the data to the cloud; further supports providing cloud APIs upwards, so that a server may issue instructions to a device by calling the cloud APIs for achieving remote control. In the embodiment of the present disclosure, the internet of things platform is used for realizing identity authentication of the terminal device and the information issuing device.
(7) Terminal devices are intermediate devices of a sensor network layer and a transmission network layer, and also the key devices of the internet of things. Through converting and collecting by the terminal device, the external sensor data may be collected, processed, and transmitted to the Internet via various network interfaces. The terminal devices in the embodiment of the present disclosure mainly are display terminal devices, such as displays, conference all-in-one machines, etc.
(8) An information issuing apparatus is used for issuing information to a terminal device which is subjected to identity authentication and succeeds in the identity authentication.

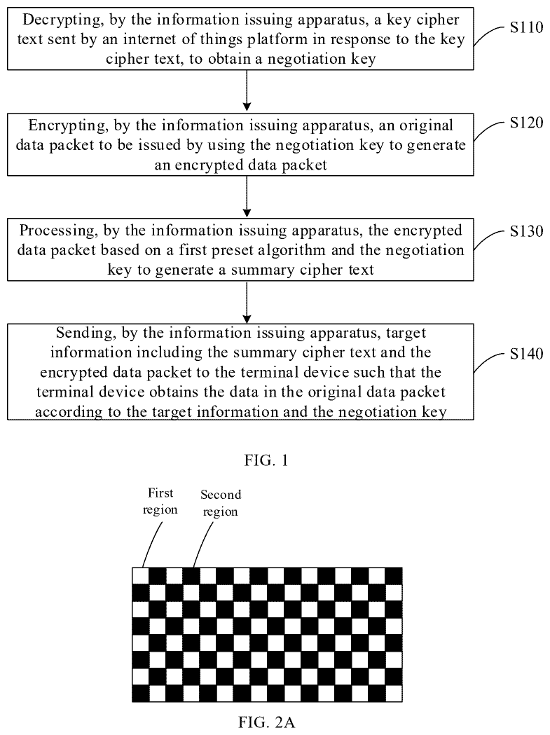

FIG. 1 is a schematic diagram of an information publishing method according to some embodiments of the present disclosure. An information publishing method shown in FIG. 1 is applied to an information issuing apparatus. As shown in FIG. 1, the information publishing method includes steps S110 to S140.

The step S110 includes: decrypting, by the information issuing apparatus, a key cipher text sent by an internet of things platform in response to the key cipher text, to obtain a negotiation key. The key cipher text is generated by the internet of things platform. The internet of things platform may perform identity authentication on a terminal device, and generates the key cipher text when the identity authentication is successful.

The step S120 includes: encrypting, by the information issuing apparatus, an original data packet to be issued by using the negotiation key to generate an encrypted data packet. The original data package includes original data of at least one data file, including at least one first original data set and at least one second original data set. The encrypted data packet includes: a first original data set of each data file and an encrypted data set generated by encrypting the second original data set by using the negotiation key.

The data file may or may not be an image. For example, if the data file is an image, the original data of the data file includes original image data of the image.

The step S130 includes: processing, by the information issuing apparatus, the encrypted data packet based on a first preset algorithm and the negotiation key to generate a summary cipher text.

The step S140 includes: sending, by the information issuing apparatus, target information including the summary cipher text and the encrypted data packet to the terminal device for obtaining the data in the original data packet by the terminal device according to the target information and the negotiation key.

In the embodiment of the present disclosure, the information issuing apparatus sends the information to the terminal device after receiving the key cipher text sent by the internet of things platform (i.e., after the identity authentication for the terminal device is successful), so as to ensure the credibility and the security of the terminal device. In the process of information transmission, the information issuing apparatus encrypts the original data packet, and then processes the encrypted data packet to generate the summary cipher text of the encrypted data packet, and transmits the summary cipher text and the encrypted data packet to the terminal device. After receiving the summary cipher text and the encrypted data packet, the terminal device may process the summary cipher text firstly to determine whether the target information is tampered in the transmission process, and if the target information is not tampered, the terminal device may further decrypt the encrypted data packet to obtain the data in the original data packet. In this way, the confidentiality and the integrity of the issued information can be ensured, and the encryption and decryption effect can be improved because only part of data (that is, the data of the second original data set) in the original data packet is encrypted and the data of the first original data set is not encrypted when the original data packet is encrypted.

In some embodiments, the step S130 may specifically include steps S131 and S132.

The step S131 includes: processing, by the information issuing apparatus, the encrypted data packet based on the first preset algorithm to generate a digital summary.

In one example, the first preset algorithm may be a hash algorithm, such as an SHA-256 algorithm.

The step S132 includes: encrypting, by the information issuing apparatus, the digital summary by using the negotiation key, to generate the summary cipher text.

In one example, the information issuing apparatus may encrypt the digital summary by using the negotiation key and a preset encryption algorithm (e.g., an AES-128 algorithm).

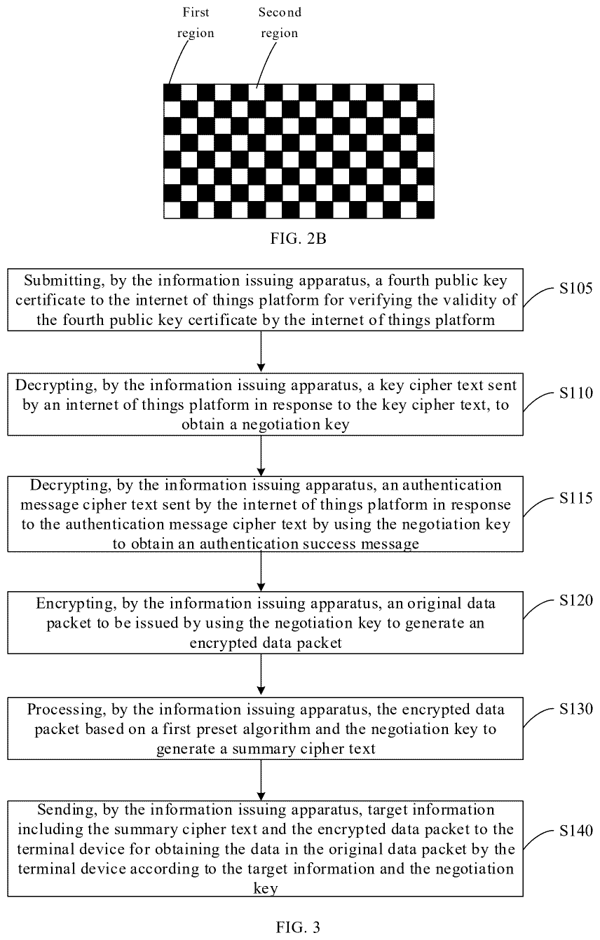

In some embodiments, the data file is an image, and the first original data set and the second original data set may include image data of different regions in the image. For example, each frame of image includes a plurality of first regions and a plurality of second regions alternately arranged in a first direction or in both the first direction and a second direction. FIG. 2A is a schematic diagram of region division of a frame of image according to some embodiments of the present disclosure. FIG. 2B is a schematic diagram of region division of another frame of image according to some embodiments of the present disclosure. As shown in FIG. 2A and FIG. 2B, each frame of image includes the plurality of first regions and the plurality of second regions arranged in an array, and the first regions and the second regions are alternately arranged in each row and each column in the array. The first original data set includes original image data of the first regions, and the second original data set includes original image data of the second regions. The first regions and the second regions are uniformly and alternately arranged, and the original image data of the second regions is encrypted, so that a demand of an encryption and decryption algorithm on the computing power can be greatly reduced on the premise of the effective computing power, and a system delay caused by the encryption and decryption algorithm can be reduced for displaying in a scene in real time.

It should be noted that each of the first regions and the second regions includes a plurality of pixels, the original image data of the first regions (or the second regions) includes pixel data of each pixel in the first regions (or the second regions), and the pixel data includes red data, green data, and blue data of the pixel.

In some embodiments, the original data packet includes original data of a plurality of frames of images, which are arranged sequentially. In two adjacent frames of images, positions of the first regions and the second regions are complementary to each other. That is, a position of the first region of one of the two adjacent frames of images is the same as that of the second region of the other one of the two adjacent frames of images. For example, the odd-numbered frames of images are divided into regions as shown in FIG. 2A, and the even-numbered frames of images are divided into regions as shown in FIG. 2B. By encrypting the data at the positions complementary to each other (opposite to each other) in the two adjacent frames of images, a system load can be enable to be more balanced, and the requirement on the system can be reduced.

FIG. 3 is a schematic diagram of an information publishing method according to further embodiments of the present disclosure. As shown in FIG. 3, the information publishing method further includes a step S115 between the step S110 and the step S120.

The step S115 includes: decrypting, by the information issuing apparatus, an authentication message cipher text sent by the internet of things platform in response to the authentication message cipher text by using the negotiation key to obtain an authentication success message.

The authentication message cipher text is generated by the internet of things platform. For example, the internet of things platform firstly generates the authentication success message, and encrypts the authentication success message by using the negotiation key to generate the authentication message cipher text. The authentication success message is a message indicating that the terminal device has successfully authenticated.

In some embodiments, as shown in FIG. 3, before the step S110, the method may further include a step S105.

The step S105 includes: submitting, by the information issuing apparatus, a fourth public key certificate CER_D to the internet of things platform for verifying the validity of the fourth public key certificate CER_D by the internet of things platform. The fourth public key certificate CER_D records a fourth public key PUB_D of the information issuing apparatus. The validity of the fourth public key certificate CER_D is verified, that is, whether the fourth public key certificate CER_D is issued by an authentication server (i.e., the CA all-in-one machine) is verified.

After verifying that the fourth public key certificate CER_D is legal, the internet of things platform may further extract the fourth public key PUB_D in the certificate, so that the authentication success message is encrypted by using the fourth public key PUB_D to generate the authentication message cipher text. In the step S150, the information issuing apparatus may decrypt the authentication message cipher text using a fourth private key PRI_D paired and matched with the fourth public key PUB_D.

In some embodiments, before the step S105, a certificate issuing process may further be performed. FIG. 4 is a schematic diagram showing a process for issuing a certificate in some embodiments of the present disclosure. The certificate issuing process in FIG. 4 is performed by the information issuing apparatus, and specifically includes steps S101 to S103.

The step S101 includes: generating, by the information issuing apparatus, a fourth private key PRI_D and the fourth public key PUB_D which are paired and matched with each other.

The step S102 includes: sending, by the information issuing apparatus, the fourth public key PUB_D to a certification authority all-in-one machine for signing the fourth public key PUB_D by the certification authority all-in-one machine to generate the fourth public key certificate CER_D. The certification authority all-in-one machine may sign the fourth public key PUB_D by using a pre-generated second private key PRI_B.

The step S103 includes: receiving and storing, by the information issuing apparatus, the fourth public key certificate CER_D sent by the certification authority all-in-one machine.

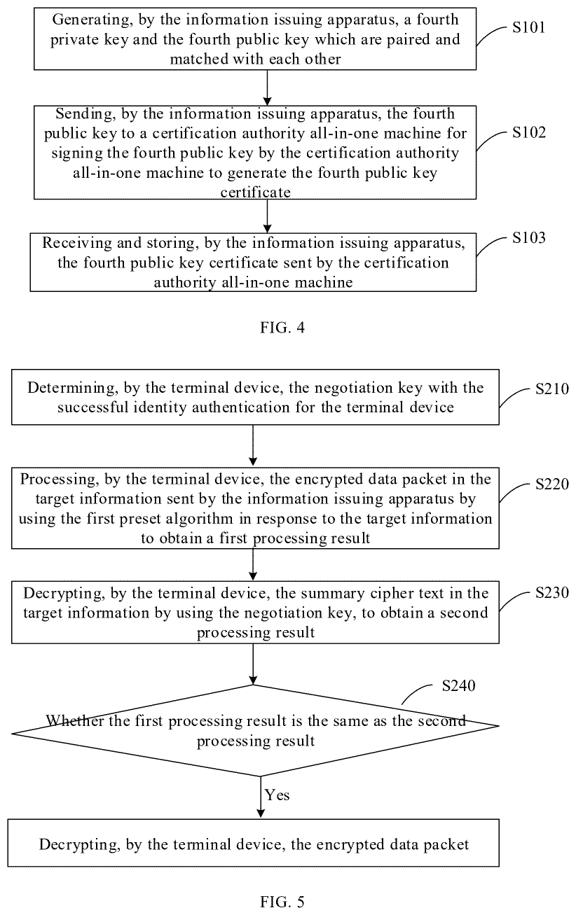

FIG. 5 is a schematic diagram of an information publishing method according to further embodiments of the present disclosure. An information publishing method shown in FIG. 5 is applied to a terminal device, and the terminal device may be a display terminal device or other terminal device. The terminal device may include a security chip, and the identity authentication may be performed by the security chip. As shown in FIG. 5, the information publishing method includes steps S210 to S240.

The step S210 includes: determining, by the terminal device, the negotiation key with the successful identity authentication for the terminal device.

In some embodiments, the negotiation key is generated in the identity authentication for the terminal device by the internet of things platform. For example, with the successful identity authentication for the terminal device, the internet of things platform may send the authentication success message to the terminal device in an encrypted or unencrypted manner. After the terminal device acquires the authentication success message, and the terminal device determines that the identity has been successfully authenticated, and determines the negotiation key. For another example, with the successful identity authentication for the terminal device, the internet of things platform may send the negotiation key to the terminal device in an encrypted or unencrypted manner.

The step S220 includes: processing, by the terminal device, the encrypted data packet in the target information sent by the information issuing apparatus by using the first preset algorithm in response to the target information to obtain a first processing result.

The step S230 includes: decrypting, by the terminal device, the summary cipher text in the target information by using the negotiation key, to obtain a second processing result.

The step S240 includes: determining, by the terminal device, whether the first processing result is the same as the second processing result, and if the first processing result is the same as the second processing result, decrypting, by the terminal device, the encrypted data packet by using the negotiation key to obtain original data of each data file in the original data packet. If the first processing result is the same as the second processing result, it indicates that the target information is not tampered in the transmission process, and the terminal device may decrypt the encrypted data packet. If the first processing result is different from the second processing result, it indicates that the target information is tampered in the transmission process, and therefore, may be discarded.

The encrypted data packet includes data to be decrypted of the at least one data file, and the data to be decrypted includes: at least one first data set and at least one second data set. The original data of the data file includes: at least one first original data set and at least one second original data set, where the at least one first original data set and the at least one first data set are one-to-one correspondence with each other and the same as each other, and the at least one second original data set and the at least one second data set are one-to-one correspondence with each other. The second data set is obtained by encrypting the second original data set by the information issuing apparatus with the negotiation key. When the terminal device decrypts the encrypted data packet by using the negotiation key, the terminal device may decrypt the second data set in the encrypted data packet by using the negotiation key to obtain the second original data set, and obtain the original data of each data file based on the second original data set and the first data set (i.e., the first original data set).

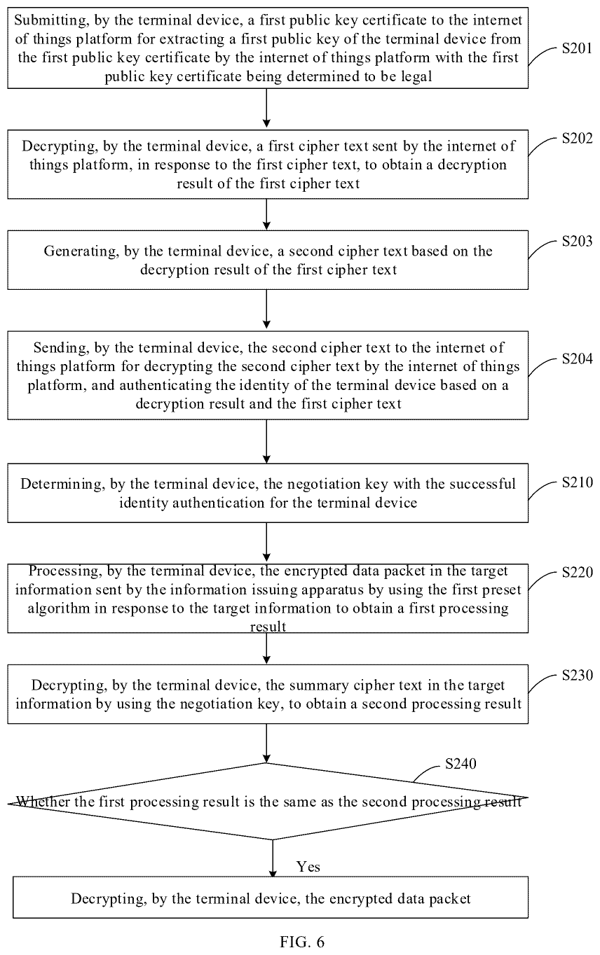

FIG. 6 is a schematic diagram of an information publishing method according to further embodiments of the present disclosure. An information publishing method shown in FIG. 6 is applied to a terminal device, and as shown in FIG. 6, the information publishing method further includes steps S201 to S204.

The step S201 includes: submitting, by the terminal device, a first public key certificate CER_A to the internet of things platform for extracting a first public key PUB_A of the terminal device from the first public key certificate CER_A by the internet of things platform with the first public key certificate CER_A being determined to be legal.

The step S202 includes: decrypting, by the terminal device, a first cipher text [R_S] sent by the internet of things platform, in response to the first cipher text [R_S], to obtain a decryption result R_S′ of the first cipher text. The first cipher text [R_S] is generated by encrypting a first random number R_S by the internet of things platform with the first public key PUB_A of the terminal device, and the first random number R_S is data randomly generated by the internet of things platform with a server cipher machine. The terminal device may decrypt the first cipher text [R_S] by using a first private key PRI_A. The first public key PUB_A is paired and matched with the first private key PRI_A.

The step S203 includes: generating, by the terminal device, a second cipher text based on the decryption result R_S′ of the first cipher text.

The terminal device may process the decryption result R_S′ of the first cipher text based on a preset rule, to generate the second cipher text. For example, the terminal device may directly encrypt the decryption result R_S′ of the first cipher text to generate the second cipher text. For another example, the terminal device may perform a specific operation on the decryption result R_S′ of the first cipher text (for example, multiplying the decryption result R_S′ by a pre-determined coefficient), and then encrypt the operation result to generate the second cipher text.

In some embodiments, the step S203 may specifically include steps S203a to S203c.

The step S203a includes: generating, by the terminal device, a third random number R_D. The third random number R_D is data randomly generated by the terminal device.

The step S203b includes: concatenating, by the terminal device, the first decryption result R_S′ and the third random number R_D to generate a second random number.

The concatenating means that a new piece of data is generated by sequentially arranging and concatenating two pieces of data. Specifically, the first decryption result may be arranged before or after the third random number. For example, the first random number R_S and the decryption result R_S′ of the first cipher text are both n-bit data, and the third random number R_D is m-bit data. The second random number R_D|R_S′ is data generated by concatenating the decryption result R_S′ of the first cipher text and the third random number R_D, and the third random number R_D is arranged before the decryption result R_S′ of the first cipher text.

The step S203c includes: encrypting, by the terminal device, the second random number R_D|R_S′ to generate the second cipher text.

The step S204 includes: sending, by the terminal device, the second cipher text to the internet of things platform for decrypting the second cipher text by the internet of things platform, and authenticating the identity of the terminal device based on a decryption result and the first cipher text.

In some embodiments, the step S203c may specifically include steps S203c1 to S203c2.

The step S203c1 includes: extracting, by the terminal device, a third public key PUB_C of the internet of things platform from a pre-acquired third public key certificate CER_C.

The step S203c2 includes: encrypting, by the terminal device, the second random number R_D|R_S′ with the third public key PUB_C to generate the second cipher text. After receiving the second cipher text, the internet of things platform may decrypt the second cipher text by using a third private key PRI_C, to authenticate the identity of the terminal device according to the decryption result and the first cipher text. The third private key PRI_C and the third public key PUB_C are paired and matched with each other and generated in advance by the internet of things platform.

The steps S201 to S204 are equivalent to the identity authentication process performed by the terminal device. In the identity authentication process, the internet of things platform encrypts the first random number by using the first public key PUB_A of the terminal device, and the terminal device decrypts the first cipher text by using the first private key PRI_A. In addition, when the terminal device generates the second cipher text, the terminal device encrypts the second random number by using the third public key PUB_C of the internet of things platform, and the internet of things platform decrypts the second cipher text by using the third private key PRI_C. Such the authentication method equivalently verifies the security of the first private key PRI_A of the terminal device and the security of the third private key PRI_C of the internet of things platform.

In some embodiments, the step S210 specifically includes: taking, by the terminal device, the second random number as the negotiation key in response to the authentication message cipher text sent by the internet of things platform. That is, after receiving the authentication message cipher text sent by the internet of things platform, the terminal device determines that the identity authentication is successful, and decrypts the authentication message cipher text by using the second random number as the negotiation key to obtain the authentication success message. The authentication success message may serve as an end marker of the identity authentication process.

In other embodiments, the terminal device decrypts the authentication message cipher text by using the second random number in response to the authentication message cipher text sent by the internet of things platform, and if an identity authentication message is obtained by successful decryption, the terminal device determines that the identity authentication is successful and takes the second random number as the negotiation key.

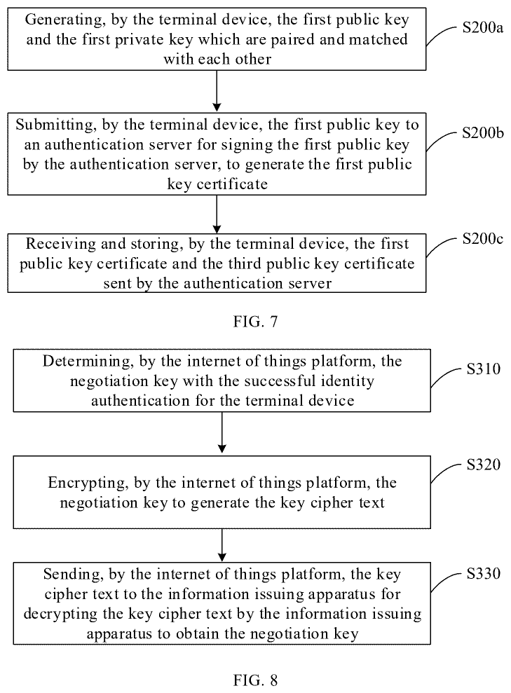

In some embodiments, a certificate issuing process is further performed prior to the identity authentication process. FIG. 7 is a schematic diagram of a certificate issuing process according to some embodiments of the present disclosure. A certificate issuing process shown in FIG. 7 is performed by a terminal device, and as shown in FIG. 7, includes steps S200a to S200c.

The step S200a includes: generating, by the terminal device, the first public key PUB_A and the first private key PRI_A paired and matched with each other.

The step S200b includes: submitting, by the terminal device, the first public key PUB_A to an authentication server for signing the first public key PUB_A by the authentication server, to generate the first public key certificate CER_A. The authentication server may sign the first public key PUB_A with the second private key PRI_B of the authentication server.

The step S200c includes: receiving and storing, by the terminal device, the first public key certificate CER_A and the third public key certificate CER_C sent by the authentication server, where the third public key certificate CER_C records the third public key PUB_C of the internet of things platform therein. In the subsequent step S203, the terminal device extracts the third public key PUB_C from the stored third public key certificate CER_C, and encrypts the second random number R_D|R_S′ by using the third public key PUB_C.

FIG. 8 is a schematic diagram of an information publishing method according to some embodiments of the present disclosure. An information publishing method shown in FIG. 8 is applied to an internet of things platform. As shown in FIG. 8, the information publishing method includes S310 to S330.

The step S310 includes: determining, by the internet of things platform, the negotiation key with the successful identity authentication for the terminal device.

The step S320 includes: encrypting, by the internet of things platform, the negotiation key to generate the key cipher text.

The step S330 includes: sending, by the internet of things platform, the key cipher text to the information issuing apparatus for decrypting the key cipher text by the information issuing apparatus to obtain the negotiation key.

In some embodiments, the internet of things platform may encrypt the negotiation key by using the public key of the information issuing apparatus, and the information issuing apparatus decrypts the received key cipher text by using the private key.

Specifically, the step S320 may include steps S320a and S320b.

The step S320a includes: extracting, by the internet of things platform, the fourth public key PUB_D of the information issuing apparatus from the pre-acquired fourth public key certificate CER_D.

The step S320b includes: encrypting, by the internet of things platform, the negotiation key by using the fourth public key PUB_D. After receiving the key cipher text, the information issuing apparatus decrypts the key cipher text by using the fourth private key PRI_D which is paired and matched with the fourth public key PUB_D.

In some embodiments, after the step S330, the method may further include steps S340 to S350.

The step S340 includes: generating, by the internet of things platform, the authentication success message.

The step S350 includes: encrypting, by the internet of things platform, the authentication success message by using the negotiation key to generate the authentication message cipher text, and sending, by the internet of things platform, the authentication message cipher text to the terminal device and the information issuing apparatus.

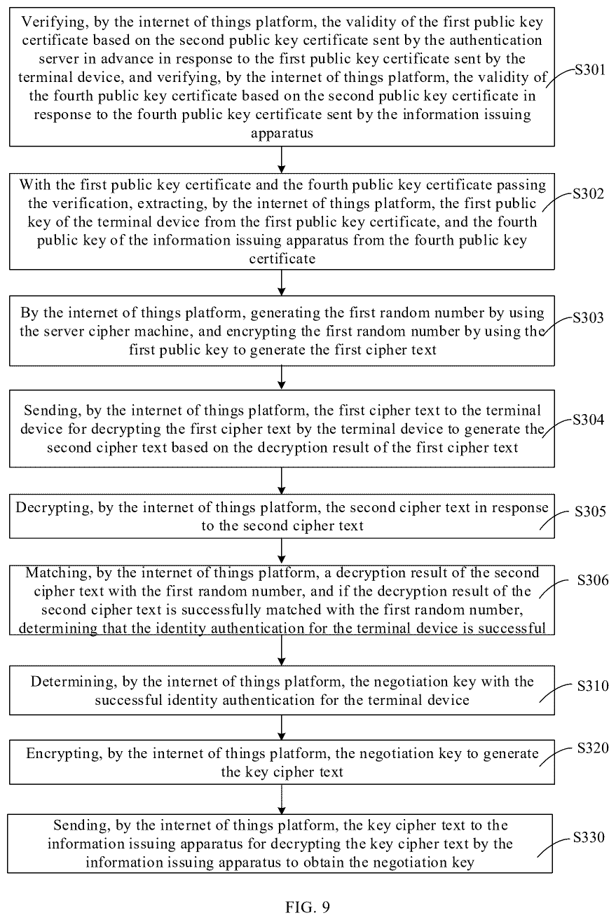

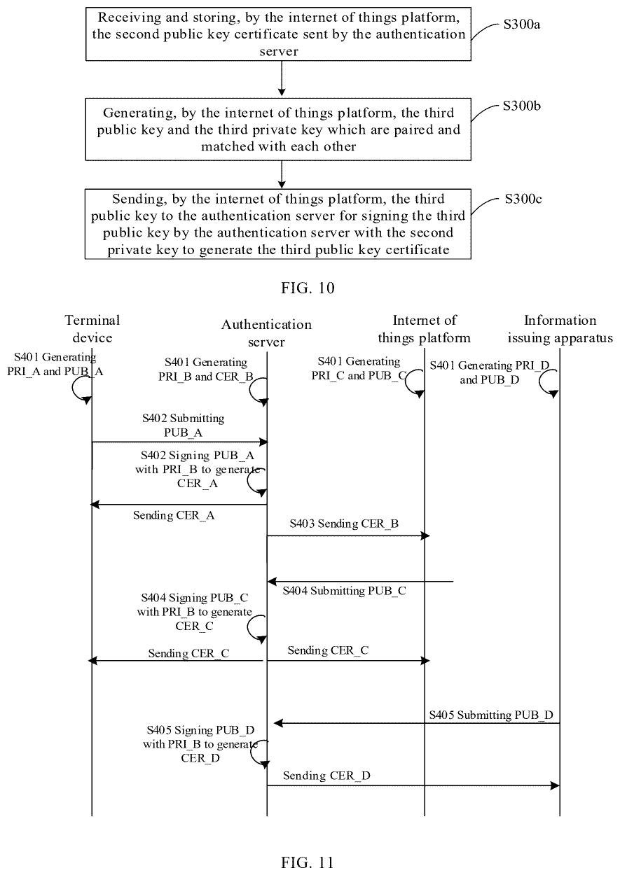

FIG. 9 is a schematic diagram of an information publishing method according to further embodiments of the present disclosure. The information publishing method shown in FIG. 9 is applied to an internet of things platform. As shown in FIG. 9, the information publishing method further includes steps S301 to S306.

The step S301 includes: verifying, by the internet of things platform, the validity of the first public key certificate CER_A based on the second public key certificate CER_B sent by the authentication server in advance in response to the first public key certificate CER_A sent by the terminal device, and verifying, by the internet of things platform, the validity of the fourth public key certificate CER_D based on the second public key certificate CER_B in response to the fourth public key certificate CER_D sent by the information issuing apparatus.

In some embodiments, the process of verifying the validity of the first public key certificate CER_A includes steps S301a and S301b.

The step S301a includes: extracting, by the internet of things platform, the second public key PUB_B of the authentication server from the second public key certificate CER_B sent by the authentication server in advance.

The second public key certificate CER_B is generated in advance by the authentication server, and records the second public key PUB_B therein.

The step S301b includes: verifying, by the internet of things platform, a signature of the first public key certificate CER_A by using the second public key PUB_B. If the signature of the first public key certificate CER_A passes the verification, it is determined that the first public key certificate CER_A actually received by the internet of things platform is issued by the authentication server, that is, it is determined that the first public key certificate CER_A is legal.

In some embodiments, the process of verifying the validity of the fourth public key certificate CER_D by the internet of things platform includes steps S301c and S301d.

The step S301c includes: extracting, by the internet of things platform, the second public key PUB_B of the authentication server from the second public key certificate CER_B sent by the authentication server in advance.

The step S301d includes: verifying, by the internet of things platform, a signature of the fourth public key certificate CER_D by using the second public key PUB_B. If the signature of the fourth public key certificate CER_D passes the verification, it is determined that the fourth public key certificate CER_D actually received by the internet of things platform is issued by the authentication server, that is, it is determined that the fourth public key certificate CER_D is legal.

It should be noted that in the step S301, the validity of the first public key certificate CER_A may be verified through steps S301a and S301b, and if it is determined that the first public key certificate CER_A is valid, step S301d is performed; if it is determined that the first public key certificate CER_A is illegal, the subsequent steps are not performed. Alternatively, the validity of the fourth public key certificate CER_D may be verified through steps S301c and S301d, and if it is determined that the fourth public key certificate CER_D is valid, step S301b is performed; if it is determined that the fourth public key certificate CER_D is illegal, the subsequent steps are not performed. Alternatively, it is possible to perform the steps S301b and S301d in parallel after extracting the second public key PUB_B.

The step S302 includes: with the first public key certificate CER_A and the fourth public key certificate CER_D passing the verification, extracting, by the internet of things platform, the first public key PUB_A of the terminal device from the first public key certificate CER_A, and the fourth public key PUB_D of the information issuing apparatus from the fourth public key certificate CER_D.

The step S303 includes: generating, by the internet of things platform, the first random number R_S by using the server cipher machine, and encrypting the first random number R_S by using the first public key PUB_A to generate the first cipher text [R_S].

The step S304 includes: sending, by the internet of things platform, the first cipher text [R_S] to the terminal device for decrypting the first cipher text [R_S] by the terminal device to generate the second cipher text based on the decryption result R_S′ of the first cipher text.

For example, after the internet of things platform sends the first cipher text [R_S] to the terminal device, the terminal device decrypts the first cipher text [R_S], and directly encrypts the decryption result R_S′ of the first cipher text to generate the second cipher text (which is hereinafter referred to as a first method). For another example, the terminal device may concatenate the decryption result R_S′ of the first cipher text with another random number, and encrypt the resultant data to generate the second cipher text (which is hereinafter referred to as a second method).

The step S305 includes: decrypting, by the internet of things platform, the second cipher text in response to the second cipher text.

The step S306 includes: matching, by the internet of things platform, a decryption result of the second cipher text with the first random number R_S, and if the decryption result of the second cipher text is successfully matched with the first random number R_S, determining that the identity authentication for the terminal device is successful.

For example, in some embodiments, the terminal device generates the second cipher text by using the first method. In this case, in the step S306, if the internet of things platform determines that the decryption result of the second cipher text is the same as the first random number, it indicates that the matching is successful. In other embodiments, the terminal device generates the second cipher text by using the second method. In this case, in the step S306, if the internet of things platform determines that a part of the decryption result of the second cipher text is the same as the first random number, it indicates that the matching is successful.

In order to improve the reliability of the identity authentication, in a preferred embodiment, the second cipher text is generated by encrypting the second random number by the terminal device with the third public key PUB_C of the internet of things platform, the second random number is generated by concatenating the decryption result of the first cipher text and the third random number by the terminal device, and the third random number is generated by the terminal device randomly. For example, the first random number R_S and the decryption result R_S′ of the first cipher text are both n-bit data, and the third random number R_D is m-bit data. The second random number R_D|R_S′ is data obtained by concatenating the decryption result R_S′ of the first cipher text and the third random number R_D, and the third random number R_D is arranged before the decryption result R_S′ of the first cipher text. Accordingly, in the step S305. the internet of things platform decrypts the second cipher text by using the third private key PRI_C. The third public key PUB_C is paired and matched with the third private key PRI_C. In the step S306, if the last n bits of data of the decryption result of the second cipher text are equal to the first random number, it is considered that the decryption result of the second cipher text is matched with the first random number, and the decryption result of the second cipher text is the same as the second random number.

When the decryption result of the second cipher text is matched with the first random number, it indicates that the private key used for the device terminal and the private key used for the internet of things platform are both safe, that is, the identity authentication for the terminal device is successful. In this case, the internet of things platform uses the decryption result of the second cipher text (i.e., the second random number) as the negotiation key.

In some embodiments, a certificate issuing process is further performed before the step S301. FIG. 10 is a schematic diagram of a certificate issuing process according to some embodiments of the present disclosure. The certificate issuing process shown in FIG. 10 is applied to the internet of things platform, as shown in FIG. 10, the certificate issuing process includes steps S300a to S300c.

The step S300a includes: receiving and storing, by the internet of things platform. the second public key certificate CER_B sent by the authentication server, where the second public key certificate CER_B records the second public key PUB_B of the authentication server therein.

The step S300b includes: generating, by the internet of things platform, the third public key PUB_C and the third private key PRI_C which are paired and matched with each other.

The sequence of the steps S300a and S300b is not particularly limited.

The step S300c includes: sending, by the internet of things platform, the third public key PUB_C to the authentication server for signing the third public key PUB_C by the authentication server with the second private key PRI_B to generate the third public key certificate CER_C, where the second public key PUB_B is paired and matched with the second private key PRI_B. After the authentication server generates the third public key certificate CER_C, the authentication server may send the third public key certificate CER_C to the terminal device, so that the terminal device extracts the third public key PUB_C to encrypt the second random number in the identity authentication process.

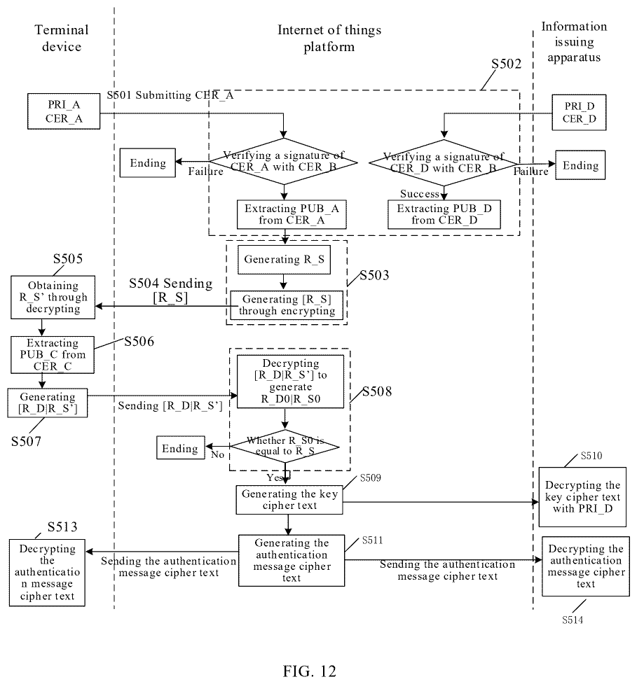

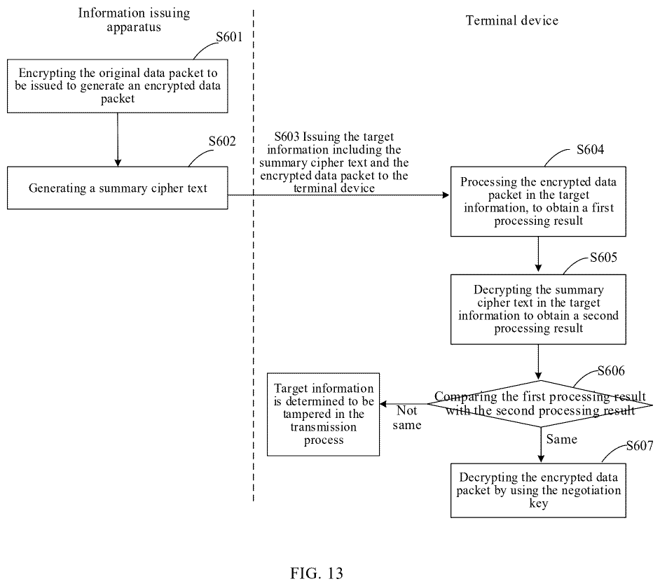

The information publishing method for the information publishing system will be described below with reference to the drawings, where the information publishing system includes: the terminal device, the authentication server, the internet of things platform, and the information issuing apparatus, and the information publishing method includes: the certificate issuing process, the identity authentication process and the information issuing process. FIG. 11 is a diagram illustrating a certificate issuing process of an information publishing system according to some embodiments of the present disclosure. FIG. 12 is a schematic diagram of an identity authentication process of an information publishing system according to some embodiments of the present disclosure. FIG. 13 is a schematic diagram of an information issuing process of an information publishing system according to some embodiments of the present disclosure. As shown in FIG. 11, the certificate issuing process includes steps S401 to S405.

The step S401 includes: generating, by the terminal device, the first public key PUB_A and the first private key PRI_A which are paired and matched with each other, generating, by the authentication server, the second private key PRI_B and the second public key certificate CER_B, generating, by the internet of things platform, the third public key PUB_C and the third private key PRI_C which are paired and matched with each other, and generating, by the information issuing apparatus, the fourth public key PUB_D and the fourth private key PRI_D which are paired and matched with each other.

The step S402 includes: submitting, by the terminal device, the first public key PUB_A to the authentication server, signing, by the authentication server, the first public key PUB_A by using the second private key PRI_B, to generate the first public key certificate CER_A of the terminal device, and sending, by the authentication server, the first public key certificate CER_A to the terminal device.

The step S403 includes: sending, by the authentication server, the second public key certificate CER_B to the internet of things platform.

The step S404 includes: submitting, by the internet of things platform, the third public key PUB_C to the authentication server, signing, by the authentication server, the third public key PUB_C by using the second private key PRI_B, to generate the third public key certificate CER_C of the internet of things platform, and sending, by the authentication server, the third public key certificate CER_C to the terminal device. In one example, the authentication server may further send the third public key certificate CER_C to the internet of things platform.

The step S405 includes: submitting, by the information issuing apparatus, the fourth public key PUB_D to the authentication server, signing, by the authentication server, the fourth public key PUB_D by using the second private key PRI_B, to generate the fourth public key certificate CER_D of the information issuing apparatus, and sending, by the authentication server, the fourth public key certificate CER_D to the information issuing apparatus.

After the certificate issuing process is finished, the terminal device stores therein: the first private key PRI_A, the first public key certificate CER_A of the terminal device and the third public key certificate CER_C of the internet of things platform. The authentication server stores therein: the second private key PRI_B and the second public key certificate CER_B of the authentication server. The internet of things platform stores therein: the third private key PRI_C, the third public key certificate CER_C of the internet of things platform and the second public key certificate CER_B of the authentication server. The information issuing apparatus stores therein: the fourth private key PRI_D and the fourth public key certificate CER_D.

As shown in FIG. 12, the identity authentication process includes steps S501 to S514.

The step S501 includes: submitting, by the terminal device, the first public key certificate CER_A to the internet of things platform; and submitting, by the information issuing apparatus, the fourth public key certificate CER_D to the internet of things platform.

The step S502 includes: verifying, by the internet of things platform, the validity of the first public key certificate CER_A in response to the first public key certificate CER_A, that is, verifying a signature of the first public key certificate CER_A by using the second public key certificate CER_B. If the signature passes the verification, which indicates that the first public key certificate CER_A is legal (that is, the first public key certificate CER_A belongs to a digital certificate issued by the authentication server), the first public key PUB_A is extracted from the first public key certificate CER_A. In addition, the internet of things platform verifies the validity of the fourth public key certificate CER_D in response to the fourth public key certificate CER_D, that is, a signature of the fourth public key certificate CER_D by using the second public key certificate CER_B. If the signature passes the verification, which indicates that the fourth public key certificate CER_D is legal (that is, the fourth public key certificate CER_D belongs to a digital certificate issued by the authentication server), the fourth public key PUB_D is extracted from the fourth public key certificate CER_D. If any one of the first public key certificate CER_A and the fourth public key certificate CER_D fails to pass the signature verification, the process is ended.

The step S503 includes: if the first public key certificate CER_A and the fourth public key certificate CER_D both pass the signature verification, generating, by the internet of things platform, the first random number R_S, and encrypting the first random number R_S by using the first public key PUB_A extracted in the step to generate the first cipher text [R_S].

The step S504 includes: sending, by the internet of things platform, the first cipher text [R_S] to the terminal device.

The step S505 includes: decrypting, by the terminal device, the first cipher text [R_S] by using the first private key PRI_A in response to the first cipher text [R_S] sent by the internet of things platform to obtain the decryption result R_S′ of the first cipher text.

The step S506 includes: extracting, by the terminal device, the third public key PUB_C from the third public key certificate CER_C.

The step S507 includes: generating, by the terminal device, the third random number R_D, and concatenating the third random number R_D and the decryption result R_S′ of the first cipher text to obtain the second random number R_D|R_S′, and encrypting the second random number R_D|R_S′ by using the third public key PUB_C to generate the second cipher text [R_D|R_S′], and sending the second cipher text [R_D|R_S′] to the internet of things platform.

The step S508 includes: decrypting, by the internet of things platform, the second cipher text [R_D|R_S′] by using the third private key PRI_C in response to the second cipher text [R_D|R_S′], where the decryption result of the second cipher text is recorded as R_D0|R_S0: determining, by the internet of things platform, whether the decryption result R_D0|R_S0 of the second cipher text is matched with the first cipher text R_S. Specifically, the internet of things platform determines whether the decryption result R_D0|R_S0 of the second cipher text is equal to the first cipher text R_S, if the decryption result R_D0|R_S0 of the second cipher text is equal to the first cipher text R_S, the identity authentication for the terminal device is determined to be successful; and otherwise, the identity authentication is determined to be failed, and the process is ended.

The step S509 includes: taking, by the internet of things platform, the decryption result of the second cipher text as the negotiation key, encrypting the negotiation key by using the fourth public key PUB_D extracted in the step S502 to generate the key cipher text, and sending the key cipher text to the information issuing apparatus.

The step S510 includes: decrypting, by the information issuing apparatus, the key cipher text by using the fourth private key PRI_D in response to the key cipher text sent by the internet of things platform, and taking the decryption result as the negotiation key.

The step S511 includes: generating, by the internet of things platform, the authentication success message, and encrypting the authentication success message through the negotiation key to generate the authentication message cipher text.

The step S512 includes: sending, by the internet of things platform, the message cipher text to the terminal device and the information issuing apparatus.

The step S513 includes: taking, by the terminal device, the second random number as the negotiation key in response to the authentication message cipher text, and decrypting the authentication message cipher text by using the negotiation key to obtain the authentication success message.

The step S514 includes: decrypting, by the information issuing apparatus, the authentication message cipher text by using the negotiation key determined in the S510 in response to the authentication message cipher text, to obtain the authentication success message. The information issuing apparatus determines that the identity authentication for the terminal device is successful.

Through the identity authentication process, the bidirectional identity authentication for both the terminal device and the internet of things platform may be completed, the identity authentication of the information issuing apparatus by the internet of things platform may be completed, and the negotiation key may be determined. The negotiation key may be used for subsequent communication, thereby providing a certificate for the identity validity of the terminal device and the information issuing apparatus.

As shown in FIG. 13, the information issuing process includes steps S601 to S607.

The step S601 includes: encrypting, by the information issuing apparatus, the original data packet to be issued by using the negotiation key to generate an encrypted data packet.

Specifically, the original data packet to be issued includes original data of a plurality of images, and each image is divided into a plurality of first regions and a plurality of second regions. For example, the plurality of first regions and the plurality of second regions of each image are arranged in an array, and the first regions and the second regions are alternately arranged in each row and each column. Positions of the first regions in the odd-numbered frames of images are the same as those of the second regions in the even-numbered frames of images, and positions of the second regions in the odd-numbered frames of images are the same as those of the first regions in the even-numbered frames of images. The original data includes a plurality of first original data sets each including original image data of the first region and a plurality of second original data sets each including original image data of the second region.

When the information issuing apparatus encrypts the original data packet, the original image data of the second region of each frame of image is encrypted by using the negotiation key, and the original image data of the first region is not encrypted, so that the data to be decrypted of each frame of image is obtained. The data to be decrypted of the frames of images forms the encrypted data packet.

The step S602 includes: processing, by the information issuing apparatus, the encrypted data packet based on a first preset algorithm (such as SHA-256 algorithm), to generate a digital summary Sh1. The digital summary Sh1 is encrypted by using the negotiation key and the AES-128 algorithm to generate a summary cipher text Sh2.

The step S603 includes: issuing, by the information issuing apparatus, the target information including the summary cipher text Sh2 and the encrypted data packet to the terminal device.

The step S604 includes: processing, by the terminal device, the encrypted data packet in the target information by using the first preset algorithm in response to the target information, to obtain a first processing result Sh3.

The step S605 includes: decrypting, by the terminal device, the summary cipher text Sh2 in the target information by using the negotiation key and the AES-128 algorithm to obtain a second processing result Sh1′.

The step S606 includes: comparing, by the terminal device, the second processing result Sh1′ with the first processing result Sh3. If the second processing result Sh1′ and the first processing result Sh3 are the same, the target information is determined not to be tampered in the transmission process, and the step S607 is performed; and otherwise, the target information is determined to be tampered in the transmission process.

The step S607 includes: decrypting, by the terminal device, the encrypted data packet by using the negotiation key. Specifically, the encrypted data packet includes data to be decrypted of each frame of image, and the data to be decrypted includes original image data of each first region and encrypted data of each second region in the image. The terminal device may decrypt the encrypted data of the second region in each frame of image by using the negotiation key, thereby obtaining the original data of each frame of image.

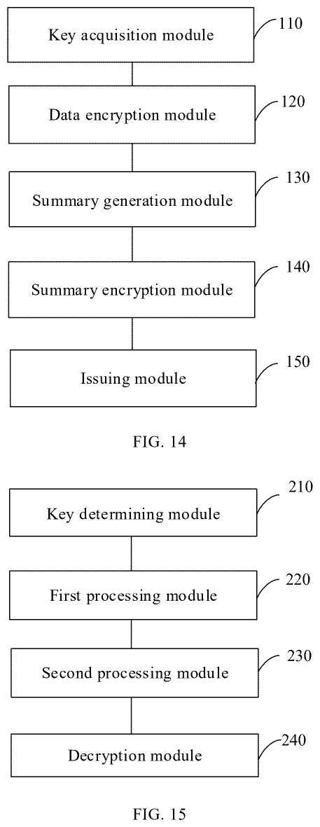

FIG. 14 is a schematic diagram of an information issuing apparatus according to some embodiments of the present disclosure. As shown in FIG. 14, the information issuing apparatus includes: a key acquisition module 110, a data encryption module 120, a summary generation module 130, a summary encryption module 140, and an issuing module 150.

The key acquisition module 110 is configured to decrypt a key cipher text sent by an internet of things platform in response to the key cipher text, to obtain a negotiation key. The key cipher text is generated with the successful identity authentication for the terminal device by the internet of things platform.

The data encryption module 120 is configured to encrypt an original data packet to be issued by using the negotiation key to generate an encrypted data packet. The original data package includes original data of at least one data file, including at least one first original data set and at least one second original data set. The encrypted data packet includes: a first original data set of each data file and an encrypted data set generated by encrypting the second original data set by using the negotiation key.

The summary generation module 130 is configured to process the encrypted data packet by using a first preset algorithm to generate a digital summary.

The summary encryption module 140 is configured to encrypt the digital summary based on the negotiation key to generate a summary cipher text.

The issuing module 150 is configured to send target information including the summary cipher text and the encrypted data packet to the terminal device for obtaining the data in the original data packet by the terminal device according to the target information and the negotiation key.

The functions of the modules refer to the above description of the information publishing method, and are not described again here.

FIG. 15 is a schematic diagram of a terminal device according to some embodiments of the present disclosure. As shown in FIG. 15, the terminal device includes: a key determining module 210, a first processing module 220, a second processing module 230, and a decryption module 240.

The key determining module 210 is configured to determine the negotiation key with the successful identity authentication for the terminal device.

The first processing module 220 is configured to process the encrypted data packet in the target information by using the first preset algorithm in response to the target information sent by the information issuing apparatus to obtain a first processing result S3.

The second processing module 230 is configured to decrypt the summary cipher text in the target information by using the negotiation key, to obtain a second processing result.

The decryption module 240 is configured to determine whether the first processing result is the same as the second processing result, and if the first processing result is the same as the second processing result, decrypt the encrypted data packet by using the negotiation key to obtain original data of each data file.

The encrypted data packet includes data to be decrypted of the at least one data file, and the data to be decrypted includes: at least one first data set and at least one second data set. The original data of the data file includes: a first original data set which is the same as the at least one first data set, and a second original data set obtained by decrypting each second data set by using the negotiation key.

The functions of the modules refer to the above description of the information publishing method, and are not described again here.

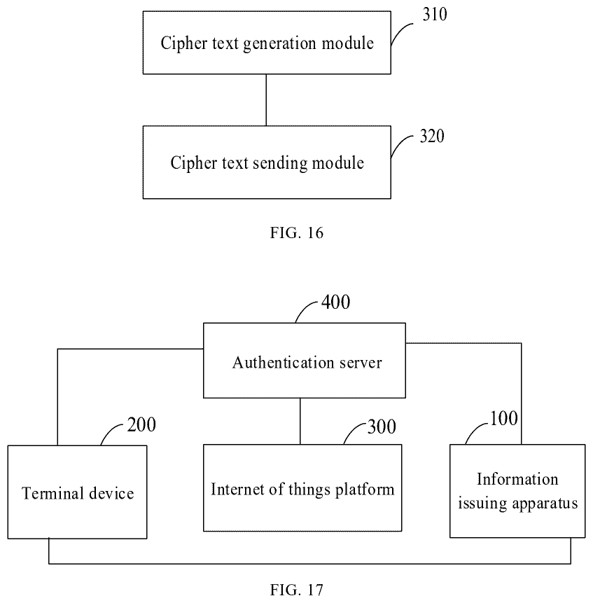

FIG. 16 is a schematic diagram of an internet of things platform according to some embodiments of the present disclosure. As shown in FIG. 16, the internet of things platform includes: a cipher text generation module 310 and a cipher text sending module 320.

The cipher text generation module 310 is configured to determine the negotiation key when it is determined that the identity authentication for the terminal device by the internet of things platform is successful: and encrypt the negotiation key to generate a key cipher text.

The cipher text sending module 320 is configured to send the key cipher text to the information issuing apparatus for decrypting the key cipher text by the information issuing apparatus to obtain the negotiation key.

The functions of the modules refer to the above description of the information publishing method, and are not described again here.

FIG. 17 is a schematic diagram of an information publishing system according to some embodiments of the present disclosure. As shown in FIG. 17, the information publishing system includes: the information issuing apparatus 100, the terminal device 200, and the internet of things platform 300.

In some embodiments, the information publishing system further includes: an authentication server 400. The authentication server 400 is configured to generate a second private key and a second public key certificate, the second public key certificate records a second public key paired and matched with the second private key therein; sign a first public key sent by the terminal device by using the second private key in response to the first public key, to generate a first public key certificate; send the first public key certificate to the terminal device; send the second public key certificate to the internet of things platform; sign a third public key sent by the internet of things platform by using the second private key in response to the third public key, to generate a third public key certificate, and send the third public key certificate to the terminal device; sign a fourth public key sent by the information issuing apparatus by using the second private key in response to the fourth public key, to generate a fourth public key certificate, and send the fourth public key certificate to the information issuing apparatus.

An embodiment of the present disclosure further provides an electronic device, which includes:
One or more processors;
A storage device having one or more programs stored thereon, which when executed by the one or more processors, cause the one or more processors to implement the information publishing method in any one of the above embodiments.

The electronic device further includes one or more I/O interfaces coupled between the one or more processors and the storage device and configured to enable information interaction between the one or more processors and the storage device.

Each processor is a device with data processing capability, which includes, but is not limited to, a Central Processing Unit (CPU) and the like. The storage device is a device with data storage capabilities, which includes, but is not limited to, random access memory (RAM, more specifically, SDRAM, DDR, etc.), Read Only Memory (ROM), Electrically Erasable Programmable Read Only Memory (EEPROM), FLASH. Each I/O interface (read/write interface) is coupled between the one or more processors and the storage device and configured to enable information interaction between the one or more processors and the storage device. The I/O interface includes but is not limited to a data bus and the like.

In some embodiments, the one or more processors, the storage device, and the one or more I/O interfaces are interconnected via a bus, which in turn coupled to other components of the computing device.

An embodiment further provides a computer-readable medium having a computer program stored thereon, where the computer program is executed by a processor to cause the processor to implement the information publishing method in any one of the embodiments above. In order to avoid repeated descriptions, detailed steps of the method will not be described herein again.

It will be understood by a person skilled in the art that all or some of the steps of the methods, functional modules/units in systems, devices in the present disclosure may be implemented as software, firmware, hardware, or suitable combinations thereof. In a hardware implementation, the division between functional modules/units mentioned in the above description does not necessarily correspond to the division of physical components. For example, one physical component may have multiple functions, or one function or step may be performed by several physical components in cooperation. Some or all of the physical components may be implemented as software executed by a processor, such as a central processing unit, a digital signal processor, or a microprocessor, or implemented as hardware, or implemented as an integrated circuit, such as an application specific integrated circuit. Such software may be distributed on a computer-readable medium which includes a computer storage medium (or non-transitory medium) and communication medium (or transitory medium). As well known to a person skilled in the art, the term “computer storage medium” includes volatile and nonvolatile, removable and non-removable medium implemented in any method or technology for storage of information such as computer-readable instructions, data structures, program modules or other data. The computer storage medium may include but not limited to, RAM, ROM, EEPROM, FLASH or other memory technology, CD-ROM, Digital Versatile Disks (DVD) or other optical disk storage, magnetic cassettes, magnetic tape, magnetic disk storage or other magnetic storage devices, or any other medium which can be used to store the desired information and which can be accessed by a computer. In addition, it is well known to a person skilled in the art that communication medium typically includes computer-readable instructions, data structures, program modules or other data in a modulated data signal such as a carrier wave or other transport mechanism and may include any information delivery medium.

It should be noted that in this document, the terms “include”, “comprise”, or any other variation thereof, are intended to cover a non-exclusive inclusion, such that a process, method, article, or apparatus that includes a list of elements not only include those elements but also may include other elements not expressly listed or inherent to such process, method, article, or apparatus. Without further limitation, an element identified by the phrase “including an . . . ” does not exclude the presence of other identical elements in the process, method, article, or apparatus that includes the element.

It will be understood that the above embodiments are merely exemplary embodiments employed to illustrate the principles of the present disclosure, and the present disclosure is not limited thereto. It will be apparent to a person skilled in the art that various changes and modifications can be made therein without departing from the spirit and essence of the present disclosure, and these changes and modifications are to be considered within the scope of the present disclosure.

1. An information publishing method for an information issuing apparatus, wherein the information publishing method comprises:
decrypting a key cipher text sent by an internet of things platform in response to the key cipher text, to obtain a negotiation key; wherein the key cipher text is generated with a successful identity authentication for a terminal device by the internet of things platform;
encrypting an original data packet to be issued by using the negotiation key to generate an encrypted data packet; wherein the original data package comprises original data of at least one data file, the original data of each data file comprises at least one first original data set and at least one second original data set, and the encrypted data packet comprises: the first original data set of each data file and an encrypted data set generated by encrypting the second original data set by using the negotiation key;
processing the encrypted data packet based on a first preset algorithm and the negotiation key to generate a summary cipher text; and
sending target information comprising the summary cipher text and the encrypted data packet to the terminal device for obtaining data in the original data packet by the terminal device according to the target information and the negotiation key.

2. The information publishing method according to claim 1, wherein the processing the encrypted data packet based on the first preset algorithm and the negotiation key, comprises:
processing the encrypted data packet based on the first preset algorithm to generate a digital summary; and
encrypting the digital summary by using the negotiation key to generate the summary cipher text.

3. The information publishing method according to claim 1, wherein each data file is an image, and the image comprises a plurality of first regions and a plurality of second regions which are arranged in an array and are alternately arranged in each row and each column in the array; and
the first original data set comprises original image data of the plurality of first regions, and the second original data set comprises original image data of the plurality of second regions.

4. The information publishing method according to claim 2, wherein the original data packet comprises: original data of a plurality of frames of images, and in every two adjacent frames of images, positions of the plurality of first regions and the plurality of second regions are complementary to each other.

5. The information publishing method according to claim 1, wherein after the decrypting the key cipher text sent by the internet of things platform in response to the key cipher text, the information publishing method further comprises:
in response to an authentication message cipher text sent by the internet of things platform, decrypting the authentication message cipher text by using the negotiation key to obtain an authentication success message;
wherein the encrypting the original data packet to be issued by using the negotiation key is performed after the authentication success message is obtained.

6. The information publishing method according to one claim 1, wherein before the decrypting the key cipher text sent by the internet of things platform in response to the key cipher text, the information publishing method further comprises:
submitting a fourth public key certificate to the internet of things platform for verifying validity of the fourth public key certificate by the internet of things platform; wherein the fourth public key certificate records a fourth public key of the information issuing apparatus therein; and
the decrypting the key cipher text, comprises:
decrypting the key cipher text by using a fourth private key; wherein the fourth public key and the fourth private key are paired and matched with each other and are all generated in advance by the information issuing apparatus; and
before the submitting the fourth public key certificate to the internet of things platform, the information publishing method further comprises:
generating the fourth private key and the fourth public key which are paired and matched with each other;
sending the fourth public key to a certification authority all-in-one machine for signing the fourth public key by the certification authority all-in-one machine to generate the fourth public key certificate; and
receiving and storing the fourth public key certificate sent by the certification authority all-in-one machine.

7. (canceled)

8. An information publishing method for a terminal device, wherein the information publishing method comprises:
determining a negotiation key with a successful identity authentication for the terminal device;
in response to target information sent by an information issuing apparatus, processing an encrypted data packet in the target information by using a first preset algorithm to obtain a first processing result;
decrypting a summary cipher text in the target information by using the negotiation key, to obtain a second processing result; and
determining whether the first processing result is the same as the second processing result, and decrypting the encrypted data packet by using the negotiation key to obtain original data of at least one data file in an original data packet if it is determined that the first processing result is the same as the second processing result;
wherein the encrypted data packet comprises data to be decrypted of the at least one data file, the data to be decrypted comprises: at least one first data set and at least one second data set, the original data of the data file comprises: a first original data set which is the same as each of the at least one first data set, and a second original data set obtained by decrypting each of the at least one second data set by using the negotiation key.

9. The information publishing method according to claim 8, wherein the information publishing method further comprises:
submitting a first public key certificate to an internet of things platform for extracting a first public key of the terminal device from the first public key certificate by the internet of things platform with the first public key certificate being determined to be legal;
in response to a first cipher text sent by the internet of things platform, decrypting the first cipher text, wherein the first cipher text is generated by encrypting a first random number by the internet of things platform with the first public key, and the first random number is data randomly generated by the internet of things platform with a server cipher machine;
generating a second cipher text based on a decryption result of the first cipher text; and
sending the second cipher text to the internet of things platform for decrypting the second cipher text by the internet of things platform, and authenticating an identity of the terminal device based on a decryption result and the first cipher text.

10. The information publishing method according to claim 9, wherein the generating the second cipher text based on the decryption result of the first cipher text, comprises:
generating a third random number;
concatenating the first decryption result and the third random number to generate a second random number; and
encrypting the second random number to generate the second cipher text.

11. The information publishing method according to claim 10, wherein the encrypting the second random number, comprises:
extracting a third public key of the internet of things platform from a third public key certificate which is acquired in advance; and
encrypting the second random number by using the third public key.

12. The information publishing method according to claim 10, wherein the determining the negotiation key with the successful identity authentication for the terminal device, comprises: taking the second random number as the negotiation key in response to an authentication message cipher text sent by the internet of things platform; and
the information publishing method further comprises: decrypting the authentication message cipher text by using the negotiation key to obtain an authentication success message.

13. The information publishing method according to claim 9, wherein before the submitting the first public key certificate to the internet of things platform, the information publishing method further comprises:
generating a first public key and a first private key which are paired and matched with each other;
submitting the first public key to an authentication server for signing the first public key by the authentication server to generate a first public key certificate; and
receiving and storing the first public key certificate sent by the authentication server and a third public key certificate, wherein the third public key certificate records a third public key of the internet of things platform therein.

14. An information publishing method for an internet of things platform, comprising:
determining a negotiation key with a successful identity authentication for a terminal device;
encrypting the negotiation key to generate a key cipher text; and
sending the key cipher text to an information issuing apparatus for decrypting the key cipher text by the information issuing apparatus to obtain the negotiation key.

15. The information publishing method according to claim 14, wherein the encrypting the negotiation key, comprises:
extracting a fourth public key of the information issuing apparatus from a fourth public key certificate which is acquired in advance; and
encrypting the negotiation key by using the fourth public key; and
wherein after the transmitting the key cipher text to the information issuing apparatus, the information publishing method further comprises:
generating an authentication success message;
encrypting the authentication success message by using the negotiation key to generate an authentication message cipher text; and
sending the authentication message cipher text to the terminal device and the information issuing apparatus.

16. (canceled)

17. The information publishing method according to claim 14, wherein the information publishing method further comprises:
in response to a first public key certificate sent by the terminal device, verifying a validity of the first public key certificate based on a second public key certificate sent by an authentication server in advance, and in response to a fourth public key certificate sent by the information issuing apparatus, verifying a validity of the fourth public key certificate based on the second public key certificate;
extracting a first public key of the terminal device from the first public key certificate, and a fourth public key of the information issuing apparatus from the fourth public key certificate with the first public key certificate and the fourth public key certificate passing the verifying;
generating a first random number by using a server cipher machine, and encrypting the first random number by using the first public key to generate a first cipher text;
sending the first cipher text to the terminal device for decrypting the first cipher text by the terminal device to generate a second cipher text based on a decryption result of the first cipher text;
decrypting the second cipher text in response to the second cipher text; and
matching a decryption result of the second cipher text with the first random number, wherein the successful identity authentication for the terminal device is determined if the decryption result of the second cipher text is successfully matched with the first random number.

18. The information publishing method according to claim 17, wherein the determining the negotiation key with the successful identity authentication for the terminal device, comprises:
taking the decryption result of the second cipher text as the negotiation key with the successful identity authentication for the terminal device.

19. The information publishing method according to claim 17, wherein the second cipher text is generated by encrypting a second random number by the terminal device with a third public key of the internet of things platform, the second random number is generated by concatenating the decryption result of the first cipher text and a third random number by the terminal device, and the third random number is generated by the terminal device randomly; and
the decrypting the second cipher text, comprises:
decrypting the second cipher text with a third private key, wherein the third public key is paired and matched with the third private key.

20. The information publishing method according to claim 17, wherein the verifying the validity of the first public key certificate based on the second public key certificate sent by the authentication server in advance, comprises:
extracting a second public key of the authentication server from the second public key certificate sent by the authentication server in advance; and
verifying a signature of the first public key certificate by using the second public key;
wherein it is determined that the first public key certificate is legal if the signature of the first public key certificate passes the verifying; and
the verifying the validity of the fourth public key certificate based on the second public key certificate, comprises:
extracting the second public key of the authentication server from the second public key certificate sent by the authentication server in advance; and
verifying a signature of the fourth public key certificate by using the second public key;
wherein it is determined that the fourth public key certificate is legal if the signature of the fourth public key certificate passes the verifying.

21. The information publishing method according to claim 17, wherein before the verifying the validity of the first public key certificate, the information publishing method further comprises:
receiving and storing the second public key certificate sent by the authentication server, wherein the second public key certificate records a second public key of the authentication server therein;
generating a third public key and a third private key which are paired and matched with each other; and
sending the third public key to the authentication server for signing the third public key by the authentication server with the second private key to generate a third public key certificate; and
wherein the second public key is paired and matched with the second private key.

22-27. (canceled)

28. A non-transitory computer-readable medium storing computer programs which, when executed by a processor, cause the processor to perform the method according to claim 1.
